(19) United States
(12) Patent Application Publication
(10) Pub. No.: US 2023/0252906 A1
(43) Pub. Date: Aug. 10, 2023

(54) SYSTEM AND METHOD FOR PERFORMING REAL-TIME ANALYSIS OF KNOWLEDGE ASSOCIATED WITH TOPICS

(71) Applicant: Adam Edward Fee, Palo Alto, CA (US)

(72) Inventor: Adam Edward Fee, Palo Alto, CA (US)

(21) Appl. No.: 17/592,530

(22) Filed: Feb. 4, 2022

(51) Int. Cl. G09B 7/00; G09B 19/00

(52) U.S. Cl. CPC G09B 7/00; G09B 19/00

(57) ABSTRACT

System and methods are disclosed for rapid, accurate, real-time assessment of a group of participants. The system includes a control device that is in communication with a user device and participant devices. The method includes a user selecting information related to a topic and sending the information to participants' devices. The participants provide responses through their respective devices. The system collects the responses and determines an assessment result, which can be provided to the user.

### FIELD OF THE INVENTION

The present technology is in the field of computer system and, more specifically, related to assessment and instruction using a combination of images and words provided using networked devices.

### BACKGROUND

Current assessment tools lack the ability to provide expedited assessment of a group to inform instruction. Further current assessment tools are inadequate for environments that have remote participants, such as a video conference session. Additionally, current assessment performance tracking fails to maintain the integrity of the data and its authenticity, as most of the information is not secure and authentication is not provided as the information is tracked and updated. Therefore, what is needed is a system and method that provide a tool for rapid, accurate, real-time assessment of a group to inform instruction.

### SUMMARY OF THE INVENTION

In accordance with various embodiments and aspects of the invention, a system and method are disclosed that that provides a tool for rapid, accurate, real-time assessment of a group. The system includes a control device that is in communication with a user device and participant devices. The method includes a user selecting information related to a topic and sending the information to participants' devices. The participants provide responses through their respective devices. The system collects the responses and determines an assessment result, which can be provided to the user.

One advantage of the various aspects and embodiments of the invention is using assessment to allow flexible grouping of participants based on participant performance.

Yet another advantage of the various aspects and embodiments of the invention is using assessment data to provide information to a user for direct instruction and to know what to teach, when to teach, and to whom.

### BRIEF DESCRIPTION OF THE DRAWINGS

In order to more fully understand the invention, reference is made to the accompanying drawings. The invention is described in accordance with the aspects and embodiments in the following description with reference to the drawings or figures (FIG.), in which like numbers represent the same or similar elements. Understanding that these drawings are not to be considered limitations in the scope of the invention, the presently described aspects and embodiments and the presently understood best mode of the invention are described with additional detail through use of the accompanying drawings.

FIG. 1A shows a system in accordance with the various aspects and embodiments of the invention.

FIG. 1B shows a system in accordance with the various aspects and embodiments of the invention.

FIG. 1C shows a system in accordance with the various aspects and embodiments of the invention.

FIG. 2 shows a flow process in accordance with the various aspects and embodiments of the invention.

FIG. 3 shows various embodiment of non-transitory computer readable medium in accordance with the various aspects of the invention.

FIG. 4 shows various embodiments in accordance with the various aspects of the invention.

FIG. 5 shows various features and tools of the system in accordance with the various aspects of the invention.

FIG. 6 shows a word-picture matching tool of the system in accordance with the various aspects and embodiments of the invention.

FIG. 7 shows a word-picture matching tool of the system that includes using a cross-word in accordance with the various aspects and embodiments of the invention.

FIG. 8 shows a magic blackboard of the system in accordance with the various aspects and embodiments of the invention.

FIG. 9 shows a system using tokens for blockchain in accordance with the various aspects and embodiments of the invention.

### DETAILED DESCRIPTION

The following describes various examples of the present technology that illustrate various aspects and embodiments of the invention. Generally, examples can use the described aspects in any combination. All statements herein reciting principles, aspects, and embodiments as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

It is noted that, as used herein, the singular forms “a,” “an” and “the” include plural referents unless the context clearly dictates otherwise. Reference throughout this specification to “one aspect,” “an aspect,” “certain aspects,” “various aspects,” or similar language means that a particular aspect, feature, structure, or characteristic described in connection with any embodiment is included in at least one embodiment of the invention.

Appearances of the phrases “in one embodiment,” “in at least one embodiment,” “in an embodiment,” “in certain embodiments,” and similar language throughout this specification may, but do not necessarily, all refer to the same embodiment or similar embodiments. Furthermore, aspects and embodiments of the invention described herein are merely exemplary, and should not be construed as limiting of the scope or spirit of the invention as appreciated by those of ordinary skill in the art. The disclosed invention is effectively made or used in any embodiment that includes any novel aspect described herein. All statements herein reciting aspects and embodiments of the invention are intended to encompass both structural and functional equivalents thereof. It is intended that such equivalents include both currently known equivalents and equivalents developed in the future.

As used herein, an “initiator” refers to intellectual property (IP) blocks, units, or modules. The terms “initiator,” “requestor,” and “master” are used interchangeably within the scope and embodiments of the invention. As used herein, a “target” and a “slave” refer to IP blocks; the terms “target” and “slave” are used interchangeably within the scope and embodiments of the invention.

As used herein, a transaction may be a request transaction or a response transaction. Examples of request transactions include write requests and read requests. When multiple initiators send identical requests to the same target, in accordance with the various aspects of the invention, the requests are aggregated. In accordance with one aspect of the invention an “identical request” means that the request transaction has the same address, is of the same type, and has the same size; the identical request is sent from multiple initiators to one target. In accordance with one aspect of the invention an “identical request” means that the request transaction has the same address, optionally the same request type, and optionally the same length.

As used herein, a node is defined as a distribution point or a communication endpoint that is capable of creating, receiving, and/or transmitting information over a communication path or channel. Thus, a Local Area Network (LAN) may be a node, wherein several devices are connected to it and communicate with one another through the node.

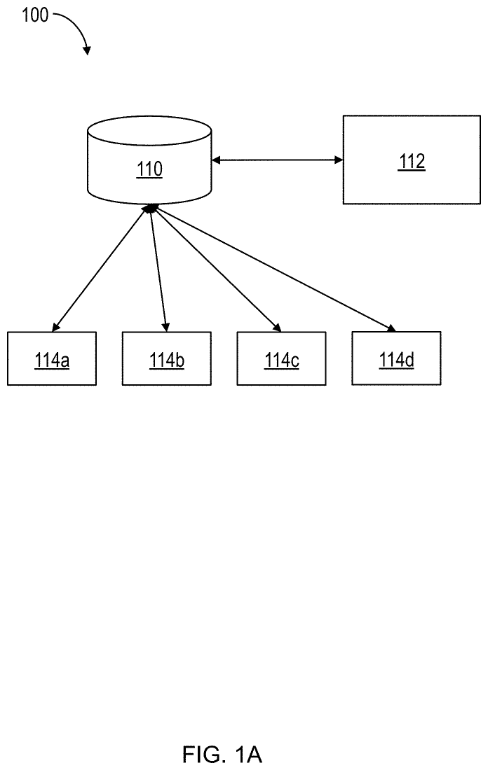

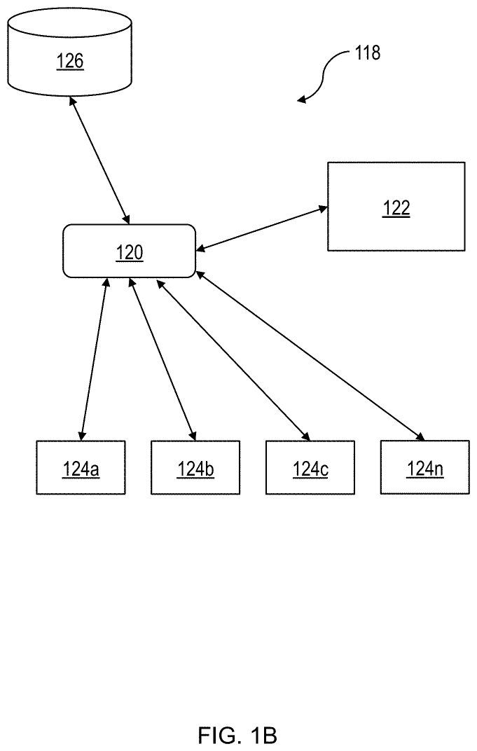

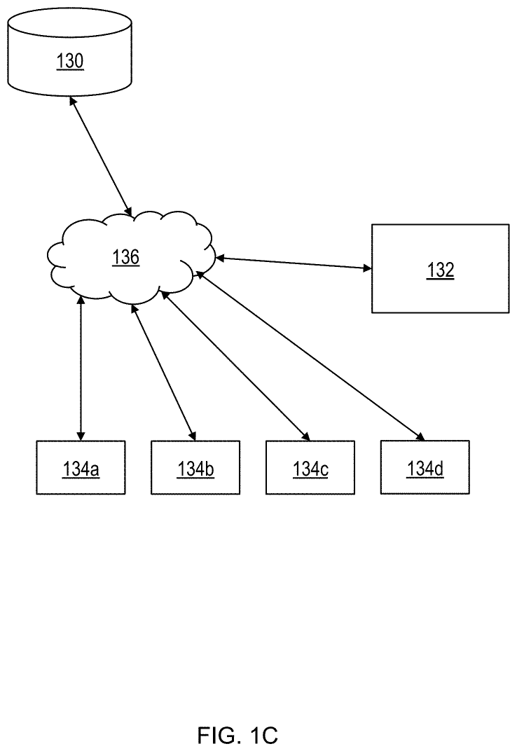

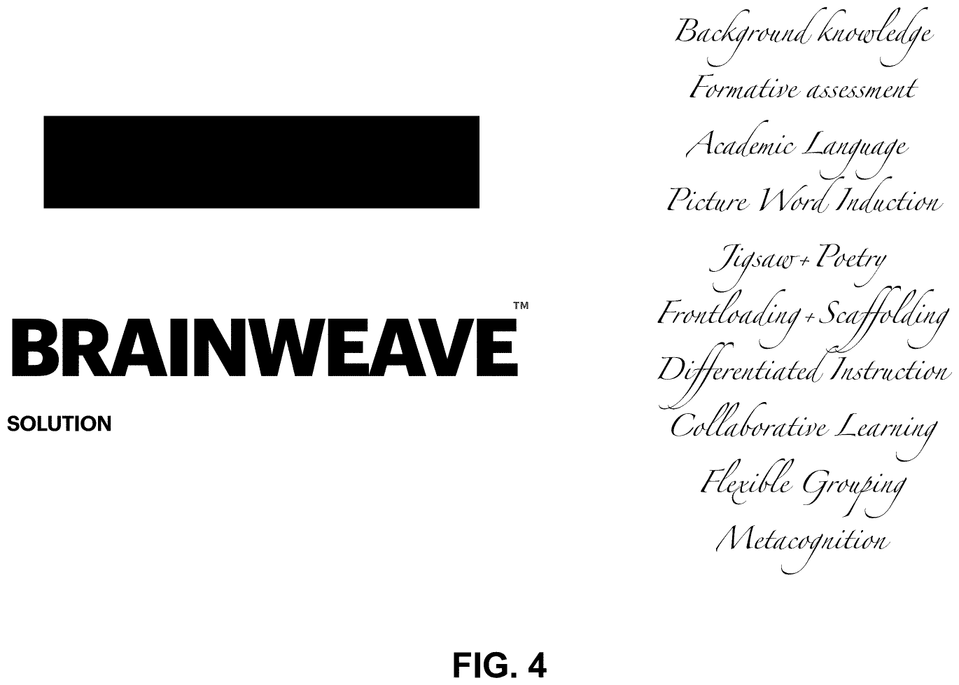

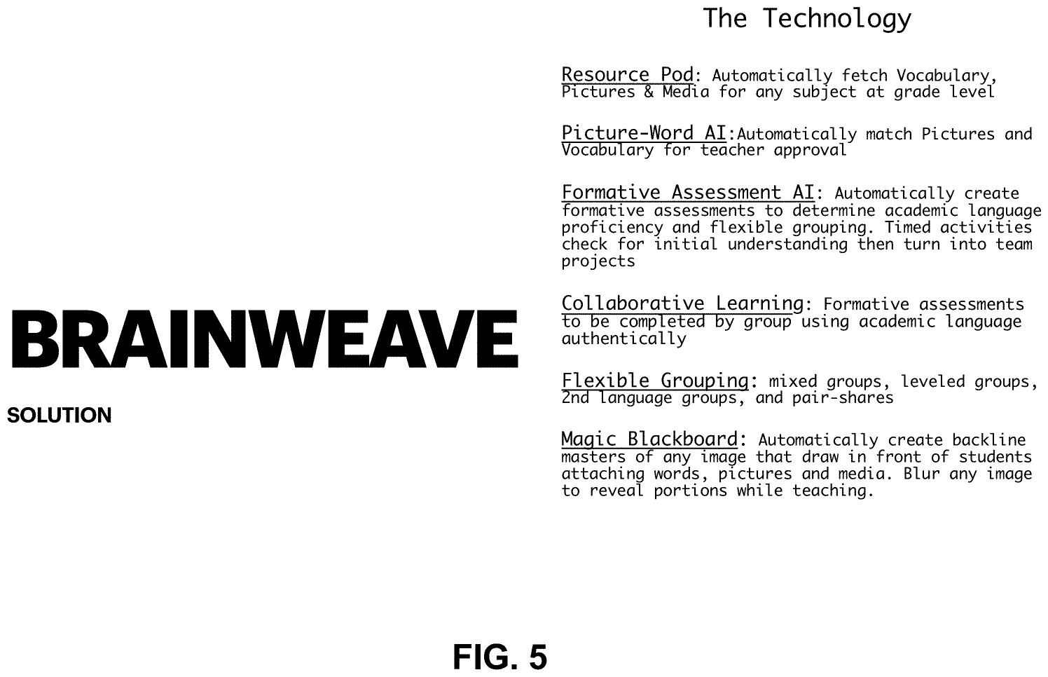

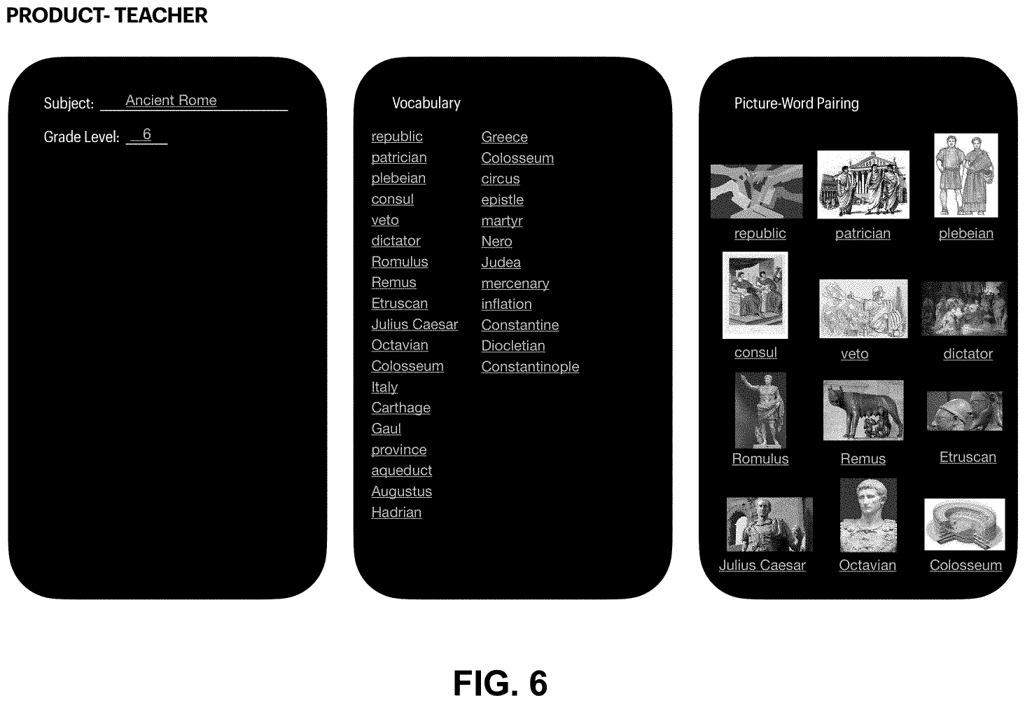

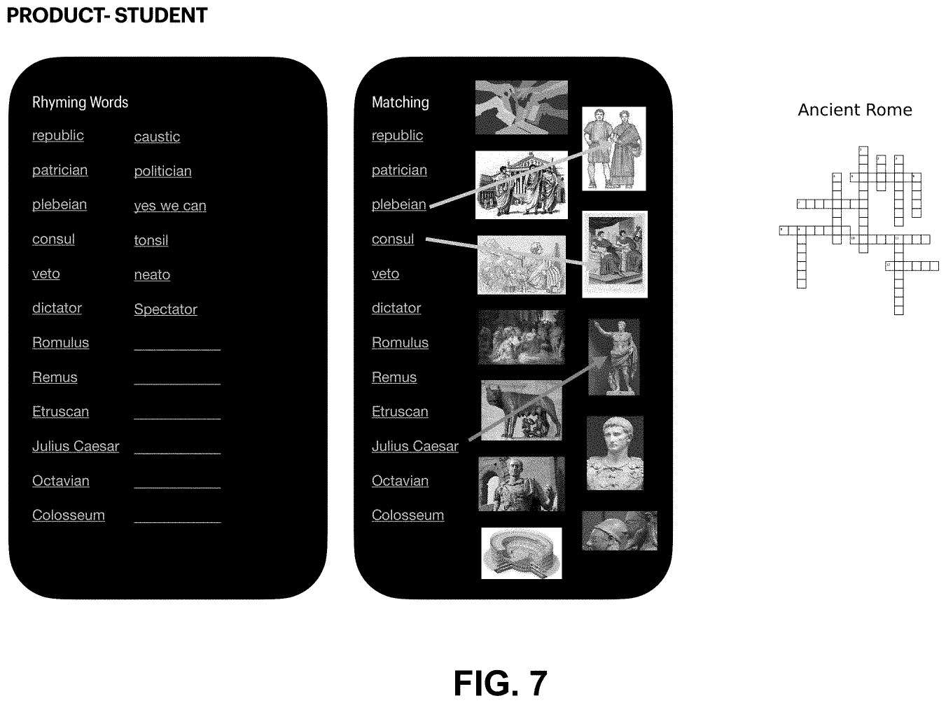

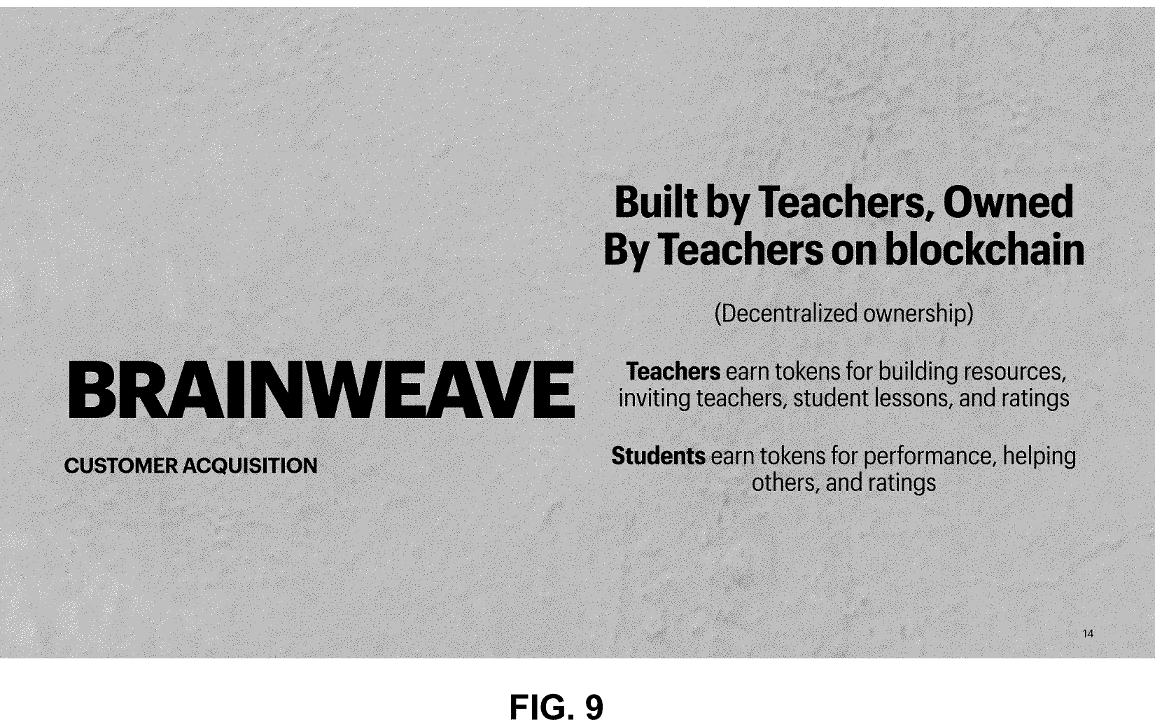

Referring now to FIG. 1A and FIG. 4-FIG. 9, a system 100 is shown for providing an assessment test in accordance with the various aspects and embodiment of the invention. As discussed below and herein, the system 100 provides several different types of assessment approaches and tools.

The system 100 includes a control device 110, a user device 112, and participant devices 114 (114a-114d). The scope of the invention is not limited by the number of devices 114; while only four is shown for simplicity, there can be any number of participants, more or less than the non-limiting example of four. The device 110 is in communication with the device 112 and the devices 114. The device 110 includes processors and memory. In accordance with the various aspects and embodiment of the invention, the device 112 and the device 114 are in direct communication with the device 110, using either a wired or a wireless communication. One example is a group of teachers and students in a school. The system 100 is set-up in the school and the devices are located in the school facility. As noted below and herein, there are other arrangements that exist with respect to the location of the devices. The device 110 stores information about many topics and uses the information for the purpose of providing an assessment tool to assess the participant's knowledge. In accordance with some aspects of the invention, the information is stored remotely at any location and is accessed by the device 110 (or the system 130 discussed in FIG. 1C) using a network connection or connection to the internet.

As used herein, the information selected (for assessment of subject matter knowledge related to the topic) includes any type of data related to the topic, academic language vocabulary, word-picture matching, crossword puzzle, rhyming words, etc. The information stored (or accessed and retrieved) includes images, emojis, emoticons, GIFs, videos, podcasts, audio, word phrases, numerical data, and image-word pairs, word translations. The device 110 receives information from input provide by the user, which is entered at the device 112. The input can be verbal through a microphone, through a keyboard, clicking using a mouse, entry with a touch screen.

In accordance with various aspects and embodiments of the invention, the system 100 (as well as all systems herein) includes a voice recognition module that analyzes the speech of any participant or the user and can determine a voice signature or voice data. The speech may be a voice command from a user, a verbal input in response to an assessment from a participant, or any verbal information. As discussed herein. a participant (or user) profile is created that includes a performance (or general) profile. The voice signature of any participant can be added to the participant profile and protected using blockchain and encryption. The voice signature can be used to authenticate access. The voice signature or voice data can be stored and updated over a period of time for each participant or user. For example, the user is a teacher using the device 112 and the teacher can provide verbal command along with other inputs to the device 112. The teacher is attempting to assess the knowledge level of the participants, which are students. Thus, the teacher selects a topic and inputs the information at the device 112. The device 112 sends the input, which was provided by the user, to the device 110. The device 110 is selects information about the topic.

In accordance with one embodiment, the information is provided to the teacher at the device 112, which the teacher can share with the participants. The teacher asks a question orally, triggers a signal to the device 110 to share multiple topic specific options with the students on the devices 114. The students can provide an input at their respective device 114, which is sent to the device 110. The device 110 collects and analyzes the response from the students. The analyzed responses or the results are provided to the teacher at the device 112. Alternatively, the analyzed responses or the results are stored in a database at the device 110.

In accordance with one embodiment, the device 110 provides the selection of images associated with the topic along with a selection of words or phrases that are related to the topic to the devices 114. The students will then be given a period of time to match the words with the images in order to demonstrate their knowledge or understanding of the topic. The input at the devices 114 are sent to the device 110. The device 110 analyzes the information received from the devices 114 to determine a performance score or ranking (based on accuracy and speed) for the students. The performance score or the ranking is sent to the device 112 for review and action by the teacher.

As the topic is selected by the teacher and provided to the device 110, the device 110 can select any number of image-word pairs to provide to the students. In accordance with one embodiment, the teacher can identify the number of image-word pairs to provide to the students, which depends on the duration of the assessment desired. In accordance with some embodiments, the teacher can also identify the complexity of the image-word pairs to provide to the students depending on the depth or complexity of the desired assessment.

In accordance with some embodiments and aspects of the invention, once the topic is identified, the device 110 can determine the best selection of information to provide to the teacher at the device 112. The teacher can then confirm the information provided for sharing or distribution with the devices 114. The students interact with the system 100 through their respective individual devices 114. The device 114 send the information provided by the students to the device 110. The system 100 analyzes and processes the information provided by the devices 114 to generate a result. The device 110 sends the results to the teacher's device 112. In an instant, the teacher is able to group or organize the students based on the results of the assessment.

In accordance with some embodiments, the teacher can provide grouping criteria to the system 100. This allows the device 110 to use the result of the assessment to group the students using the grouping criteria identified or provided by the teacher. As such, the teacher will receive, at the device 112, the students grouped based on the grouping criteria.

Referring now to FIG. 1B and FIG. 4-FIG. 9, a system 118 is shown in accordance with the various aspects and embodiment of the invention. The system 118 includes a control device 120, a user device 122, participant devices 124 (124a-124d), and a remote device 126. The device 126 may be made up of a collection or bank of servers and/or a remote data storage unit. In accordance with some embodiments and aspects of the invention, the device 126 includes processors and memory for handling analysis of information received from the device 126, which is collected from input provided at the device 122 or the devices 124.

The scope of the invention is not limited by the number of devices 124 that are included; while only four devices are shown for simplicity, there can be any number of participant devices, more or less than the non-limiting example of four. Thus, within the scope of the invention, any number of devices 124 can be in communication with the device 120.

The device 120 is a local area network or a node for communication between the device 122, the devices 124, and the device 126. The device 120 is in communication with the device 122 and the devices 124. The device 120 includes processors and memory for handling routing of communication and analysis of information. In accordance with the various aspects and embodiment of the invention, the device 122 and the devices 124 are in direct communication with the device 120, using either a wired or a wireless communication. One non-limiting example is the system 118 is set-up in the school facility. In accordance with some embodiments and aspects of the invention, the devices 124 are mobile personal communication devices that are connected to the network, such as the device 120. In accordance with some embodiments and aspects of the invention, the devices 124 are desktop devices that are located in a specific location in the school facility and connected to the device 120 using a wired connection. The various embodiments and aspects can all communicate with and receive information from the device 126.

The device 126 stores information about many topics. The device 120 is in communication with the device 126 and can access and retrieve the information for the purpose of providing assessment testing using an assessment tool. The information stored at the device 126 includes images, emojis, emoticons, gifs, videos, podcasts, audio, word phrases, numerical data, and image-word pairs, word translations. In accordance with some aspects and embodiments of the invention, the information stored at the device 126 is imaged or copied to the device 120 and updated to improve performance. In accordance with some aspects and embodiments of the invention, the device 120 retrieves information from the device 126 and does not retain the information for long-term.

The device 120 receives input provided by the user, which is entered at the device 122. The device 120 routes (sends) the information to the device 126. For example, the user is a teacher using the device 122. The teacher is attempting to assess the knowledge level of the participants, which are students. The teacher selects a topic and inputs the topic at the device 122. The device 122 sends the input, which was provided by the user, to the device 120. The device 120 routes the information to the device 126. In accordance with some aspects and embodiments of the invention, the device 126 identifies and selects information about the topic.

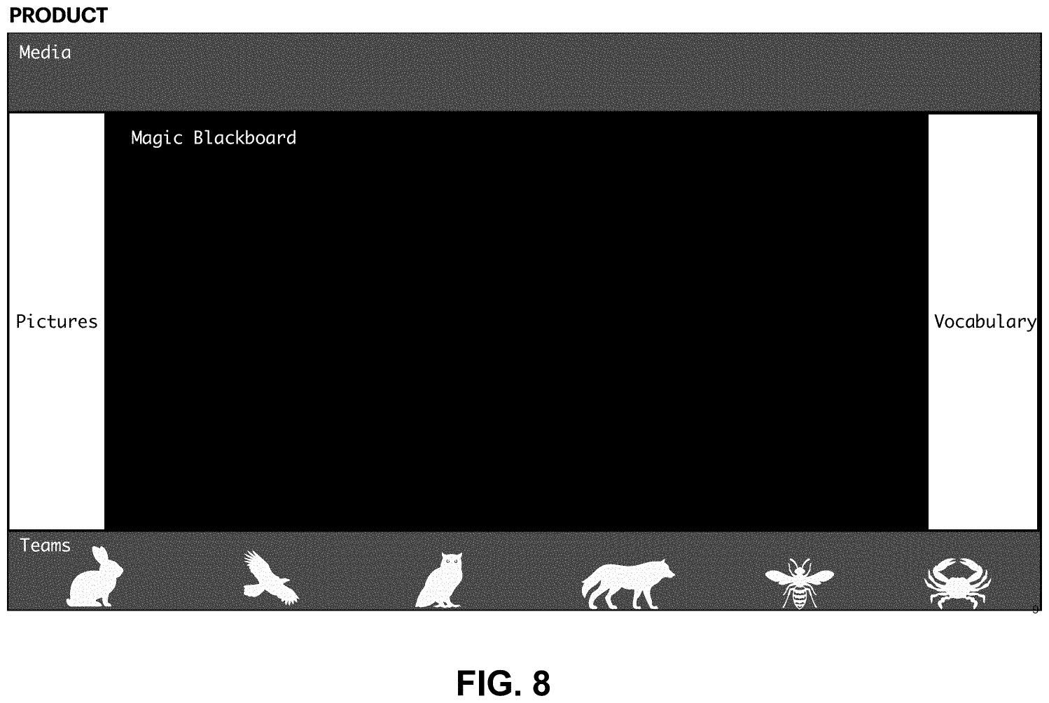

In accordance with some aspects and embodiments of the invention, the device 126 identifies the information related to the topic and sends the selected information to the device 122 (through the device 120). The information selected (that is related to the topic) may be pictures/images, text, video, audio, numerical, or any other format that can be used for providing or displaying to a participant. Referring to FIG. 8, a blackboard (display) is shown that can be used by the teacher and displayed on the device 122, with a similar blackboard displayed at the devices 124. The resulting assessment may be game like or entertaining by asking matching of picture-to-picture, text-to-text matching, video-to-video matching, or any combination including picture-to-text and video-to-description/phrase. As discussed herein, the assessment provides the ability to quickly test a group or participants using various parameters, such as limiting time.

In accordance with some aspects and embodiments of the invention, the information already exists at the device 120, perhaps from a previous topic request or previous assessment test. The information related to the topic is provided to the teacher and the teacher selects the information to customize the assessment test, instead of having it automatically selected based on a teacher-set-criteria that was previously provided by the teacher. For example, the teacher-set-criteria could be related to the duration of the assessment or the difficulty of the assessment and the teacher may wish to customize the assessment information and, hence, the test.

In accordance with one embodiment, the information is provided to the teacher at the device 122, which the teacher can share with the participants or instruct the system 118 to share with the devices 124. For example, the teacher asks a question orally, triggers sending or sends a signal from the device 122 to the device 120. The trigger signal causes sharing of multiple topic specific options with the students on the devices 124. The students can provide an input at their respective device 124, which is sent to the device 120. The device 120 collects and analyzes the response from the students. The analyzed responses or the results are provided to the teacher at the device 122. Alternatively, the analyzed responses or the results are stored in a database at the device 120.

In accordance with one embodiment, the device 120 provides the selection of images associated with the topic along with a selection of words or phrases that are related to the topic to the devices 124. The students will then be given a period of time to match the words with the images in order to demonstrate their knowledge or understanding of the topic. The input at the devices 124 are sent to the device 120. The device 120 analyzes the information received from the devices 124 to determine a performance score or ranking (based on accuracy and speed) for the students. The performance score or the ranking is sent to the device 122 for review and action by the teacher.

In accordance with some aspects and embodiments of the invention, information (related to the topic) in the form of images are provided to the device 122. The image or images can be seen by the teacher on the device 122; the images are not shown on the devices 124. The teacher selects an image. In accordance with one embodiment and aspect of the invention, the system generates a blackline master for the image. In accordance with other aspects and embodiments of the invention, the system selects a blackline master that matches the image from the blackline masters stored in a database, some of which may have been created by the system previously. The system blackline master can be manually or automatically traced out in front of students. For example, when using video conferencing (participants at remote terminals) the tool allows the teacher can select any image. The selected image is turned it into a black line master. The teacher can manually (or the system automatically) trace it out in front of the participants, while the teacher narrates and/or pauses the tracing. In accordance with some aspects and embodiments, the image is presented in whole. In accordance with some aspects and embodiments, parts or portions of the image are presented. In accordance with some aspects and embodiments, the images include multiple objects within the image. In order to focus the attention of the participants on the object related to the topic of the lesson and not the other objects, the system can blur out the objects that are not relevant to the topic and leaves only the relevant object (in the image) in focus while the teacher is teaching. For example, consider an image with troop movements in WWII that has multiple objects in the image. The system blurs the entire image presented to the participants except the object in the image that is related to the topic being taught.

In accordance with some aspects and embodiments of the invention, the system's tool may also be used by the participants to provide a presentation to other participants and the teacher. The system allows access by the participants to images and the tracing tool feature. The participant can provide a presentation to the group, in smaller group, between the individual, and/or the teacher. Additionally, the system can allow group presentation to other groups or the teacher.

Using this tracing tool, the teacher begins to trace portions of the images on the display of the device 122. As such, the portion of the image traced by the teacher begins to appear on the display of the devices 124. In response to the tracing, the system 118 then provides words or phrases to the devices 124 and begin the assessment. In accordance with some aspects and embodiments of the invention, the phrases are provided in advance, before the teacher begins tracing on the display of device 122. In accordance with some aspects and embodiments of the invention, the traced information on the device 122 is sent to the devices 124 as the teacher is tracing and explaining or discussing the portion of the image that is traced. For example, the topic may be the human body and the teacher traces the fingers and discusses information about the fingers. The level and depth of instruction is informed by the assessment results.

In accordance with some aspects and embodiments of the invention, the assessment requires matching between words/numbers and images. Thus, the topic selected is provided to the device 126 through the device 120. The device 120 queries the device 126 for the image-word pairs related to the topic. In accordance with some aspects and embodiments of the invention, the device 120 selects image-word pairs to provide to the students based on information stored about the topic at the device 120.

In accordance with one embodiment, the teacher sets the total number of image-word pairs to provide to the students. For example, the teacher may want a short assessment and, hence, selects a low number of image-word pairs. In accordance with some embodiments, the teacher can also identify the complexity of the image-word pairs to provide to the students depending on the depth or complexity of the desired assessment.

In accordance with some embodiments and aspects of the invention, once the topic is identified, the device 120 can determine the best selection of information to provide to the teacher at the device 122. The teacher can then confirm the information provided for sharing or distribution with the devices 124. The students interact with the system 118 through their respective individual devices 124. The devices 124 send the information provided by the students to the device 120. In accordance with some aspects and embodiments of the invention, the system 118 analyzes and processes the information provided by the devices 124 at the device 126 and generates a result. In accordance with some aspects and embodiments of the invention, the system 118 analyzes and processes the information provided by the devices 124 at the device 120 and generates a result. The device 120 sends the results to the teacher's device 122.

In an instant, the teacher is provided assessment results at the device 122 and the teacher is able to group or organize the students based on the results of the assessment. In accordance with some embodiments, the teacher can provide grouping criteria to the system 118. This allows the device 120 (or the device 126) to use the result of the assessment to group the students using the grouping criteria identified or provided by the teacher. As such, the teacher will receive, at the device 122, the students already grouped based on the grouping criteria.

Referring now to FIG. 1C and FIG. 4-FIG. 9, a system 130 is shown that allows assessment of participants connected using an internet-based communication protocol in accordance with the various aspects and embodiment of the invention, the system 130 is connected to a network, such as the internet 136, and initiates a networked communication session. In accordance with some embodiments and aspects of the invention, the system 130 includes a neural network model or an artificial intelligence (AI) model that is trained to access information related to the topic, determine the quality of the information used in the assessment, and through adversarial neural network or generative adversarial networks (GANs) provide feedback to the system 130 and improve/update the model. As assessment tests are generated and each new assessment test provides data related to quality of the test, the accumulation of the data can be used to train the model (e.g., provided to educational institution or publishers). Thus, the system can collect and accumulate training data that can be sold or provided for training other models. This allows for improved knowledge (by the model) for selection of images and language that is most effective or most popular for achievement of the most ideal assessment. The data can be shared with different models for training purpose of those models. The system 130 includes a control unit for processing requests and a communication unit for handling communication of responses to the requests received. The system 130 is in communication with a user device 132 and participant devices 134 (134a-134d) through the internet 136. In accordance with some embodiments and aspects of the invention, the internet 136 handles routing of information, which is collected from input provided at the device 132 or the devices 134.

The scope of the invention is not limited by the number of devices 134 that are shown; while only four devices are shown as a non-limiting example and for simplicity, there can be any number of participant devices, which may be more or less than the non-limiting example of four. Thus, within the scope of the invention, any number of devices 134 can be in communication with the system 130 and device 132, all through the internet 136.

The internet 136 acts as a communication connection point or a node for communication between the device 132, the devices 134, and the device 126. The system 130 is in communication with the device 132 and the devices 134. The system 130 includes processors and memory for handling routing of communication and analysis of information. In accordance with the various aspects and embodiment of the invention, the device 132 and the devices 134 are all remotely located. A communication session is established using the internet 136 to allow the user of device 132 to conduction a session with the devices 134. In accordance with some embodiments and aspects of the invention, the devices 134 can be any type of device capable of connecting to the internet 136 and receiving information from the system 130 and/or the device 132. For example, the devices 134 are mobile personal communication devices, desk-top computers, laptop computers, personal communication devices, or any other type of machine that is capable of receiving and processing and storing information. The various embodiments and aspects can all communicate with and receive information from/through the internet 136.

The system 130 stores information about many topics. The system 130 is in communication with the device 132 and the devices 134. The system 130 accesses and retrieves information for the purpose of providing assessment testing of the participant using the devices 134. The information stored at the system 130 includes images, emojis, emoticons, gifs, videos, podcasts, audio, word phrases, numerical data, and image-word pairs, word translations. In accordance with some aspects and embodiments of the invention, the information stored at the system 130 is imaged or copied to the device 132 and updated as needed. In accordance with some aspects and embodiments of the invention, the device 132 retrieves information from the system 130 and does not retain the information in long-term storage or memory.

The system 130 receives input provided by the user, which is entered at the device 132. The system 130 routes (sends) information to the device 134. For example, the user is a teacher using the device 132. The teacher is attempting to assess the knowledge level of the participants, which are students connected via video conference session from their respective devices. The teacher selects a topic and inputs the topic at the device 132. The device 132 sends the input, which was provided by the user, to the system 130. In accordance with some aspects and embodiments of the invention, the system 130 identifies and selects information about the topic.

In accordance with some aspects and embodiments of the invention, the system 130 identifies the information related to the topic and sends the selected information to the device 132 (through the internet 136 communication session or connection). In accordance with some aspects and embodiments of the invention, The information related to the topic is provided to the teacher and the teacher selects the information to customize the assessment test, instead of having it automatically selected based on a teacher-set-criteria that was previously provided by the teacher. For example, the teacher-set-criteria could be related to the duration of the assessment or the difficulty of the assessment and the teacher may wish to customize the information and, hence, the assessment test.

In accordance with one embodiment, the information is provided to the teacher at the device 132, which the teacher can share with the participants. In accordance with some embodiments, the teacher (through device 132) instructs the system 130 to share the information with the devices 134. For example, the teacher asks a question orally, then initiates sharing (triggers sending or sends a signal from the device 132) with the devices 134 using the system 130. The trigger signal causes sharing of multiple topic related choices or options with the students (on the devices 134) for selection by the students. The students can provide an input at their respective device 134, which input is sent to the system 130. The system 130 collects and analyzes the response from the students to determine subject matter knowledge. In accordance with some aspects and embodiments of the invention, the analysis of the results is correlated to a score to indicate subject matter knowledge related to any topic. For example, the topic may be language and the score is an indicator of proficiency in the user's ability to speak and understand the language

The analyzed responses or the results are provided to the teacher at the device 132. Alternatively, the analyzed responses or the results are stored in a database at the system 130. In accordance with one embodiment and various aspects of the invention, the system 130 sends the collected information to the device 132. The device 132 analyzes the information locally to determine the result for each student.

In accordance with one embodiment and various aspects of the invention, the system 130 provides the assessment test to the devices 134. The information that is used to build or create the assessment test includes a selection of images associated with the topic along with a selection of words or phrases that are related to the topic. The students will then be given a period of time to match the words with the images in order to demonstrate their knowledge or understanding of the topic. The input at the devices 134 are sent to the system 130. The system 130 analyzes the information received from the devices 134 to determine a performance score or ranking (based on accuracy and speed) for each participant. The performance score or the ranking is sent from the system 130 to the device 132 for review and further action by the teacher. For example, the teacher may group the students based on similarity of test score or result. Another example would be grouping the student so that there are higher ranking students grouped with lower ranking students to create an environment for peer-to-peer sharing or instruction. In accordance with one embodiment and various aspects of the invention, the pairings may be image-image pairing or word-word pairing, all of which depend on the objective of the assessment test or the desired testing parameters.

In accordance with some aspects and embodiments of the invention, the system 130 sends information (related to the topic and in the form of images) to the device 132. The image or images can be seen by the teacher on the device 132; the images are not shown on the devices 134. The teacher, using a tracing tool that is provided as part of the assessment tool, begins to manually or automatically trace portions of different objects in the image on the display (e.g., interactive or touch sensitive display) of the device 132. The portion of the image, which is traced by the teacher, begins to appear on the display of the devices 134 as the image is traced at the device 132. The system 130 then provides words or phrases to the devices 134 and begins the assessment test.

In accordance with some aspects and embodiments of the invention, the phrases are provided in advance, before the teacher begins tracing an outline on the display of device 132. In accordance with some aspects and embodiments of the invention, the traced information on the device 132 is sent to the devices 134 as the teacher is tracing and explaining or discussing the portion of the image that is traced. For example, the topic may be a spider and the teacher traces the spider's legs and discusses information about the legs. This allows for the participants to see the image traced and hear the information. Later an assessment test can be generated by the system 130 using the information associated with the tracing by the teacher and the words used by the teacher. For example, a microphone of the device 132 can capture the speech spoken by the teacher. The spoken words can be time correlated to the tracing action. The system 130 receives the speech, converts the speech to text, and provides the text (with the traced portion of the image) as part of the image-word pairing during an assessment testing on this topic.

In accordance with some aspects and embodiments of the invention, the assessment requires matching between words/numbers and images. Thus, the topic selected is provided to the system 130. The system 130 receives queries on the information for the image-word pairs (or image-image pairing or image-number pairs or number-number pairs) related to the topic. In accordance with some aspects and embodiments of the invention, the system 130 selects image-word pairs to provide to the participant an assessment evaluation based on information stored about the topic at the system 130.

In accordance with one embodiment, the teacher sets the total number of image-word pairs to provide to the students. For example, the teacher may want a short assessment and, hence, selects a low number of image-word pairs. In accordance with some embodiments, the teacher can also identify the complexity of the image-word pairs to provide to the students depending on the depth or complexity of the desired assessment.

In accordance with some aspects and embodiments of the invention, the teacher is provided assessment results at the device 132 and the teacher is able to group or organize the students based on the results of the assessment. In accordance with some embodiments, the teacher can provide grouping criteria to the system 130. This allows the system 130 to use the result of the assessment test to group the students using the grouping criteria identified or provided by the teacher. As such, the teacher will receive, at the device 132, the students already grouped based on the grouping criteria.

In accordance with some embodiments and aspects of the invention, once the topic is identified, the system 130 can determine the best selection of information to provide to the teacher at the device 132. The teacher can then confirm the information provided for sharing or distribution with the devices 134. The students interact with the system 130 through their respective individual devices 134. The devices 134 send the information provided by the students to the system 130. In accordance with some aspects and embodiments of the invention, the system 130 analyzes and processes the information provided by the devices 134 and generates individual results, which represents the performance for each participant.

In accordance with some aspects and embodiments of the invention, the system 130 collects the information from all devices 134. The system sends the collected information to the device 132. The device 132 includes a program or application that analyzes and processes the information, which was collected from the devices 134 at the system 130. The device 132 generates a result that is local and at the device 132. As such, the device 132 can generate the result locally without depending on an established or existing communication session with the system 130. The device 132 can later send the results to the system 130. The individual participant results may be shared with each respective device 134 for that participant. The individual participate results are retained over a period of time for each participant.

In accordance with one embodiment and various aspects of the invention, each participants results are tracked and securely maintained over a period of time by the system 130 (or the device 132). The information is shared or distributed as needed. Thus, as the participant's knowledge is tested over a period of time, improvements and performance (assessment results) can be tracked and maintained in a digital record or performance profile. In accordance with one embodiment and various aspects of the invention, the individual's performance profile is secured (and encrypted) using blockchain technology. The use of blockchain allows for digital information associated with the participant (student) to be recorded and distributed, but not edited. In this way, a blockchain is the foundation for creating, updating, and maintaining immutable ledgers or records (performance profile) that cannot be altered, deleted, or destroyed. The use of encryption will allow securing the content (of the performance profile) and allowing access only to authorized people.

In accordance with one embodiment and various aspects of the invention, the users or the participants receive awards or incentives (e.g., points, credits, tokens etc.) to be used on the blockchain. These awards can be made available to trade within the blockchain and across multiple blockchains.

In accordance with one embodiment and various aspects of the invention, the performance profile is updated over time with additional assessment tests are taken and maintained using blockchain. The system 130 adds the new assessment results to the performance profile and updates the performance profile, which results in a new performance profile that is protected using blockchain and secured using encryption. Every new assessment result, which is added to the performance profile, is verified, uploaded, and secured by those having access to the blockchain for the specific performance profile.

In accordance with one embodiment and various aspects of the invention, the information used for the assessment test is identified and selected using a neural network model or an artificial intelligent (AI) model to determine the best images that are based on repeated use and quality of the assessment tests. The results of any assessment can be used to evaluate the quality of the information that was used as the basis of the assessment test. The quality data is used to train the model and update the model. In accordance with one embodiment and various aspects of the invention, the participants can provide responses to the assessment using oral or verbal input using natural language responses. The AI model can be trained on the natural language recognition to improve the model's ability to accurately detect and capture natural language responses from the participants.

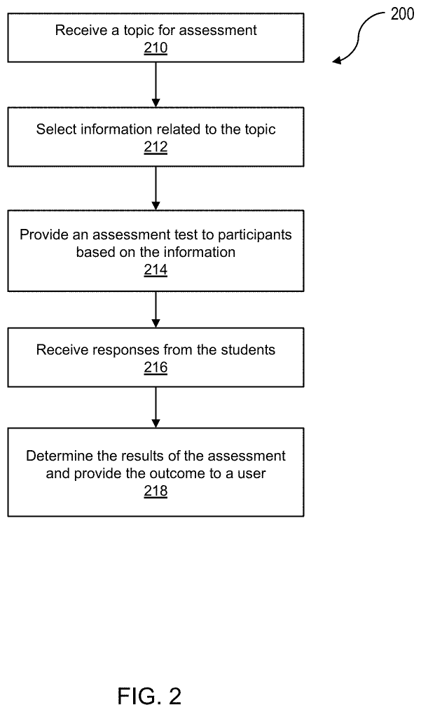

Referring now to FIG. 2 and FIG. 4-FIG. 9, a process 200 is shown for providing an assessment test to a group of participants, which are guided by a user, in accordance with the various aspects and embodiment of the invention. At step 210, the system receives the topic for assessing a group of participants. At step 212, the system selects information related to the topic. The information is any combination of words, images, or numerical values related to the topic. The information is used to generate the assessment test on the topic. At step 214 the information is provided in the form of an assessment test to the participants at their respective devices. At step 216, the system receives the input responses from the participants. At step 218, the results for the assessment test are determined and provided to the user. In accordance with one embodiment and various aspects of the invention, the results for the assessment test are determined by the system. In accordance with one embodiment and various aspects of the invention, the results for the assessment test are determined at a device that is in communication with the system.

Once the results of the assessment are analyzed and determined, the user can group participants as noted herein. Additionally, the results for each student are added to the performance profile for each participant. The integrity of the performance profile is maintained using blockchain and encryption.

Certain methods according to the various aspects of the invention may be performed by instructions that are stored upon a non-transitory computer readable medium. The non-transitory computer readable medium stores code including instructions that, if executed by one or more processors, would cause a system or computer to perform steps of the method described herein. The non-transitory computer readable medium includes: a rotating magnetic disk, a rotating optical disk, a flash random access memory (RAM) chip, and other mechanically moving or solid-state storage media. Any type of computer-readable medium is appropriate for storing code comprising instructions according to various example.

Certain examples have been described herein and it will be noted that different combinations of different components from different examples may be possible. Salient features are presented to better explain examples; however, it is clear that certain features may be added, modified, and/or omitted without modifying the functional aspects of these examples as described.

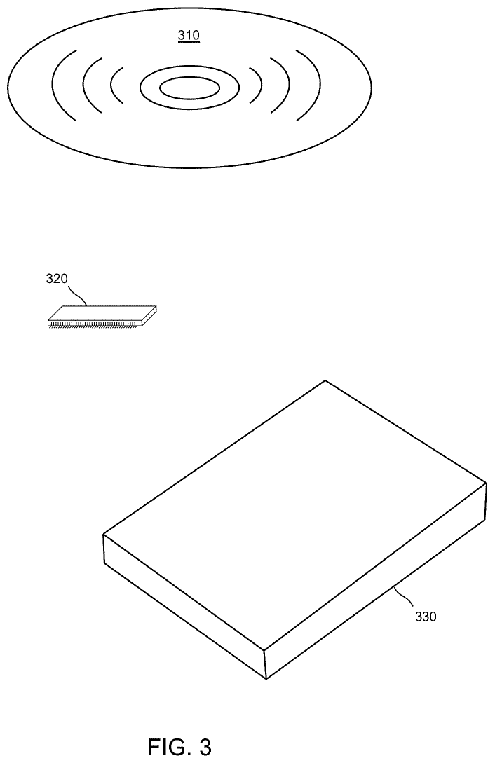

Referring now to FIG. 3, an optical CD 310, a memory chip 320, and an optical drive 330 are shown in accordance with the various embodiments of the invention for storing information related to participants and users and code, which when executed cause the system to perform methods. Examples of the memory chip 320 include solid-state storage (SSS), solid state drive (SSD), solid state card (SSC), solid state module (SSM) and flash drives. Other examples on a storage medium include magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

Various examples are methods that use the behavior of either or a combination of machines. Method examples are complete wherever in the world most constituent steps occur. For example, and in accordance with the various aspects and embodiments of the invention, IP elements or units include: processors (e.g., CPUs or GPUs), random-access memory (RAM—e.g., off-chip dynamic RAM or DRAM), a network interface for wired or wireless connections such as ethernet, WiFi, 3G, 4G long-term evolution (LTE), 5G, and other wireless interface standard radios. The IP may also include various I/O interface devices, as needed for different peripheral devices such as touch screen sensors, geolocation receivers, microphones, speakers, Bluetooth peripherals, and USB devices, such as keyboards and mice, among others. By executing instructions stored in RAM devices processors perform steps of methods as described herein.

Some examples of computer-readable storage medium may include random access memory (RAM), dynamic random access memory (DRAM), static random access memory (SRAM), fast page mode dynamic random access memory (FPM DRAM), synchronous dynamic random access memory (SDRAM), double data rate synchronous dynamic random access memory (DDR SDRAM), extended data-out dynamic random access memory (EDO DRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. Embodiments are described that use a computer-readable storage medium, other types of computer-readable storage media may be substituted for or used in addition to the computer-readable storage media described herein.

Some examples are one or more non-transitory computer readable media arranged to store such instructions for methods described herein. Whatever machine holds non-transitory computer readable medium comprising any of the necessary code may implement an example. Some examples may be implemented as: physical devices such as semiconductor chips; hardware description language representations of the logical or functional behavior of such devices; and one or more non-transitory computer readable media arranged to store such hardware description language representations. Descriptions herein reciting principles, aspects, and embodiments encompass both structural and functional equivalents thereof. Elements described herein as coupled have an effectual relationship realizable by a direct connection or indirectly with one or more other intervening elements.

Practitioners skilled in the art will recognize many modifications and variations. The modifications and variations include any relevant combination of the disclosed features. Descriptions herein reciting principles, aspects, and embodiments encompass both structural and functional equivalents thereof. Elements described herein as “coupled” or “communicatively coupled” have an effectual relationship realizable by a direct connection or indirect connection, which uses one or more other intervening elements. Embodiments described herein as “communicating” or “in communication with” another device, module, or elements include any form of communication or link and include an effectual relationship. For example, a communication link may be established using a wired connection, wireless protocols, near-filed protocols, or RFID.

To the extent that the terms “including”, “includes”, “having”, “has”, “with”, or variants thereof are used in either the detailed description and the claims, such terms are intended to be inclusive in a similar manner to the term “comprising.”

The scope of the invention, therefore, is not intended to be limited to the exemplary embodiments and aspects that are shown and described herein. Rather, the scope and spirit of the invention is embodied by the appended claims.

What is claimed is:

1. A method for assessment of participants, the method comprising:
receiving a topic for assessment;
selecting information related to the topic;
sending the information to each of the participants' devices;
receiving responses from the participants;
determining assessment results; and
providing the assessment results to a user for evaluation of each participant's performance.

2. The method of claim 1, wherein the information is subject matter specific and includes at least one pair selected from the group including: words, images, videos, and numerals specific to the topic.

3. The method of claim 2, wherein the participant matches each part of the pair to a corresponding part of the pair.

4. The method of claim 2, wherein a defined grouping rule is used to define a score range and a group of the participants based on the scores that fall within the score range.

5. The method of claim 4, wherein flexible grouping can be employed where the defined grouping rule results in a group of at least one user with a high score and at least one user with a low score, wherein the high score is above a first threshold score and the low score is below a second threshold score.

6. The method of claim 1 further comprising:
analyzing accuracy of the responses; and
providing a score for each of the participants.

7. The method of claim 1, wherein each assessment result is represented by a score that falls into one defined score range selected from a plurality of score ranges and the users are grouped using a defined grouping rule that takes into account the plurality of score ranges.

8. The method of claim 1, wherein the topic is language and the score determines proficiency in the user's ability to speak and understand the language.

9. The method of claim 1, wherein the participants provide responses use to complete assessments individually or in groups and the verbal commands are stored as voice data that is authenticated and each of the participants' input is tracked over a period of time to determine progress.

10. The method of claim 9, wherein authenticating and tracking of each users' input uses blockchain to allow analysis and evaluation over a period of time while maintaining authenticity.

11. The method of claim 1, wherein the information is performed using an artificial intelligence (AI) model and the AI model is trained using feedback based on the information.

12. The method of claim 11, wherein the AI model augments any one of the participants' scores based on speed of the users' performance on the assessments.

13. The method of claim 12, wherein the AI model can provide the plurality of pictures as an outline image on a main display and upon tracing of the outlined image on the main display, the traced portion of the image is presented on each of the participants' display.

14. The method of claim 1, wherein the participants' scores are tracked over a period of time as score data and the score data are authenticated on blockchain implementation to allow tracking of users' progress over a period of time.

15. The method of claim 1, wherein the information includes a plurality of pictures and each of the plurality of pictures are broken down into a plurality of image parts and each image part is provided to the users using a predefined timing.

16. The method of claim 1, wherein an artificial intelligence (AI) model receives the plurality of pictures and, using tags associated with objects in the plurality of pictures, segments the plurality of pictures into a plurality of images, wherein each of the images represent one object in the plurality of pictures and includes a tag selected from the tags.

17. The method of claim 16, wherein the plurality of images are provided to the participants in real-time as images are traced on a master display to allow the users to see partial images as images are outlined on the master display.

18. A non-transitory computer readable medium comprising code that is executed by a processor to cause an assessment tool to:
receive a topic for assessment;
select information related to the topic;
send the information to each of the participants' devices;
receive responses from the participants;
determine assessment results; and
provide the assessment results to a user for evaluation of each participant's performance.
